(19) United States
(12) Patent Application Publication
(10) Pub. No.: US 2013/0109298 A1
(43) Pub. Date: May 2, 2013

(54) TERMINAL AND METHOD OF COMMUNICATING IN THE SAME

(71) Applicants: Electronics and Telecommunications Research In, Daejeon (KR); Industry-Academic Cooperation Foundation Chosu, Gwangju (KR)

(72) Inventors: Won-Ik KIM, Daejeon (KR); Eunkyung KIM, Daejeon (KR); Sung Kyung KIM, Daejeon (KR); Sung Cheol CHANG, Daejeon (KR); Mi Young YUN, Daejeon (KR); Seokki KIM, Gyeonggi-do (KR); Hyun LEE, Daejeon (KR); Chul Sik YOON, Seoul (KR); Kwang Jae LIM, Daejeon (KR); Seokjoo SHIN, Gwangju (KR)

(73) Assignees: Industry-Academic Cooperation Foundation, Chosun University, Gwangju (KR); Electronics and Telecommunications Research Institute, Daejeon (KR)

(21) Appl. No.: 13/664,987

(22) Filed: Oct. 31, 2012

(30) Foreign Application Priority Data
Nov. 1, 2011 (KR) 10-2011-0112965
Sep. 25, 2012 (KR) 10-2012-0106635

(51) Int. Cl. H04W 88/04

(52) U.S. Cl. 455/11.1

(57) ABSTRACT

A terminal and a method of communicating in the same are provided. The terminal includes a terminal mode unit that supports a terminal mode and a relay mode unit that supports a relay mode, and the terminal mode unit and the relay mode unit are connected through an internal interface. When the terminal receives an instruction that instructs to operate in a relay mode from a base station, the terminal sets a relay link with the base station, and the terminal mode unit operates as a subordinate terminal of the relay mode unit through an internal interface.

### CROSS-REFERENCE TO RELATED APPLICATION

This application claims priority to and the benefit of Korean Patent Application Nos. 10-2011-0112965 and 10-2012-0106635 filed in the Korean Intellectual Property Office on Nov. 1, 2011 and Sep. 25, 2012, the entire contents of which are incorporated herein by reference.

### BACKGROUND OF THE INVENTION

(a) Field of the Invention

The present invention relates to a terminal and a method of communicating in the same.

(b) Description of the Related Art

When a disaster or a calamity occurs, an important social infrastructure may be destroyed or damaged. Various communication facilities such as for a wireless phone, a wired phone, and an Internet network are important parts of social infrastructure, and when such a communication facility is destroyed or damaged, social congestion increases and security of society recovery may be difficult.

Therefore, even in such a situation, a high reliability support that provides a method that can quickly restore or replace a communication facility is important.

Particularly, as a base station that performs a central function of communication of a mobile terminal is damaged or as a power line is destroyed, when the base station does not perform a function thereof, a service unavailable area may occur.

Therefore, it is necessary to provide a means that can provide a wireless communication service in a service unavailable area due to damage of a base station.

### SUMMARY OF THE INVENTION

The present invention has been made in an effort to provide a terminal and a method of communicating in the same having advantages of continuing to provide a wireless communication service even when a base station is damaged.

An exemplary embodiment of the present invention provides a method of communicating in a terminal. The method includes: providing a terminal mode unit and a relay mode unit that are connected through an internal interface; receiving an instruction that instructs to operate in a relay mode in which the relay mode unit supports, from a base station (BS); setting a relay link to the BS; and performing, by the terminal mode unit, a function as a subordinate terminal of the relay mode unit through the internal interface.

The method may further include requesting to switch a data path of a terminal mode in which the relay mode unit supports, to the BS. The requesting to switch may include transmitting an advanced air interface L2 transfer (AAI-L2-XFER) message to the BS.

The relay mode may be a time division-transmit and receive (TTR) relay mode.

The receiving of an instruction may include receiving an advanced air interface-advanced relay station-config-command (AAI-ARS-CONFIG-CMD) message necessary when operating in the relay mode from the BS. The AAI-ARS-CONFIG-CMD message may include contents that request to maintain a terminal mode. The AAI-ARS-CONFIG-CMD message may include a superframe number action field, and the setting of a relay link may be started at an action time in the superframe number action field.

The method may further include, before the receiving of an instruction: receiving an advanced air interface-multimode-relay station-request (AAI-MM-RS-REQ) message that requests the relay mode from the BS; and transmitting an advanced air interface-multimode-relay station-response (AAI-MM-RS-RSP) message to the AAI-MM-RS-REQ message to the BS. The AAI-MM-RS-REQ message may include contents that request to operate in a TTR mode as the relay mode.

The AAI-MM-RS-REQ message may include contents that request to operate in a TTR mode as the relay mode and contents that request to maintain a terminal mode.

The method may further include providing a new station identifier (STID) for the terminal mode before transmitting the AAI-MM-RS-RSP message.

Another embodiment of the present invention provides a terminal. The terminal includes: a radio frequency (RF) module; and a processor including a terminal mode unit and a relay mode unit that are connected through an internal interface, wherein the processor enables a BS to set a relay link and enables the terminal mode unit to operate as a subordinate terminal of the relay mode unit through the internal interface, when a first message, which is an instruction that instructs to operate in a relay mode in which the relay mode unit supports, is received from the BS.

The processor may switch a data path of a terminal mode in which the terminal mode unit supports, by transmitting an AAI-L2-XFER message to the BS.

The relay mode may be a TTR relay mode.

The first message may be an AAI-ARS-CONFIG-CMD message necessary for operating in the relay mode.

The first message may include contents that request to maintain a terminal mode.

Yet another embodiment of the present invention provides a method of communicating in a BS. The method includes: transmitting a message that requests to operate in a relay mode to a terminal that supports the relay mode and a terminal mode; receiving a response message to the message from the terminal; and transmitting a message that instructs to operate in the relay mode while maintaining the terminal mode to the terminal. The terminal may include a relay mode unit that supports the relay mode and a terminal mode unit that supports the terminal mode, and the relay mode unit and the terminal mode unit may be connected to an internal interface.

According to an exemplary embodiment of the present invention, as a multimode HR-MS operates as a relay, a temporary network can be constructed in a service unavailable area, and the multimode HR-MS can maintain an original terminal function while operating as a relay.

According to an exemplary embodiment of the present invention, when a terminal operates as a relay, a new zone of a frame unit or a superframe unit for transmission/reception of a terminal mode thereof is unnecessary, and thus embodiment complexity does not increase.

### BRIEF DESCRIPTION OF THE DRAWINGS

FIG. 1 is a diagram illustrating a damaged base station in a mobile communication system according to an exemplary embodiment of the present invention.

FIG. 2 is a diagram illustrating an internal configuration of a multimode HR-MS and a connection relationship between the multimode HR-MS and peripheral elements according to an exemplary embodiment of the present invention.

FIG. 3 is a flowchart illustrating a method in which a multimode HR-MS forms a relay mode and a terminal mode according to an exemplary embodiment of the present invention.

FIG. 4 is a flowchart illustrating another method in which a multimode HR-MS forms a relay mode and a terminal mode according to an exemplary embodiment of the present invention.

FIG. 5 is a block diagram illustrating a configuration of a multimode HR-MS according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a mobile station (MS) may indicate a terminal, a mobile terminal (MT), a mobile station (MS), an advanced mobile station (AMS), a high reliability mobile station (HR-MS), a subscriber station (SS), a portable subscriber station (PSS), an access terminal (AT), and user equipment (UE), and may include an entire function or a partial function of the terminal, the MT, the AMS, the HR-MS, the SS, the PSS, the AT, and the UE.

Further, a base station (BS) may indicate an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) that performs a BS function, and a high reliability relay station (HR-RS) that performs a BS function, and may include an entire function or a partial function of the ABS, the node B, the eNodeB, the AP, the RAS, the BTS, the MMR-BS, the RS, and the HR-RS.

Hereinafter, a terminal and a method of communicating in the same will be described in detail with reference to the drawings.

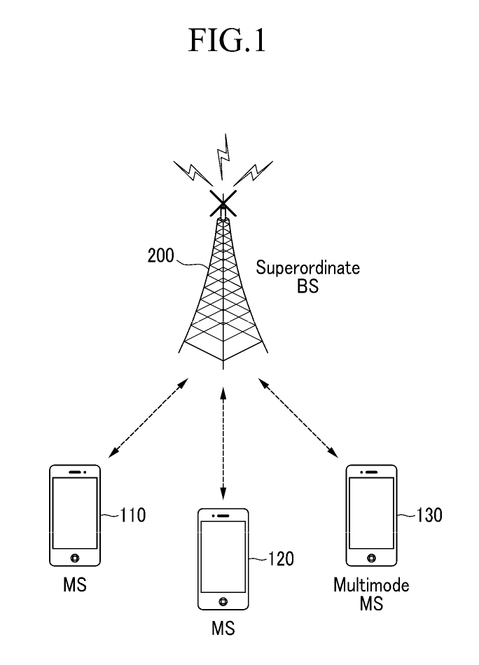

FIG. 1 is a diagram illustrating a damaged BS in a mobile communication system according to an exemplary embodiment of the present invention.

The mobile communication system according to an exemplary embodiment of the present invention includes a BS 200 and subordinate terminals 110, 120, and 130 within a cell that the BS 200 services. Here, the BS 200 is a damaged BS that does not appropriately perform a function of a BS, and hereinafter, the BS 200 is referred to a superordinate high reliability base station (superordinate HR-BS).

When the superordinate HR-BS 200 is damaged, a service unavailable area occurs and the subordinate terminals 110, 120, and 130 have a problem in providing a mobile communication service, but in an exemplary embodiment of the present invention, a terminal that performs a relay function among the subordinate terminals 110, 120, and 130 is selected. Hereinafter, a terminal that is selected as a terminal that performs a function of a relay is referred to as a multimode high reliability mobile station (multimode HR-MS). As a multimode HR-MS that is selected in this way performs a function of a relay, a temporary network is constructed and operated, and thus subordinate terminals may continue to receive a service.

A multimode HR-MS according to an exemplary embodiment of the present invention maintains an original function of a terminal while performing a function of a relay. That is, a multimode HR-MS according to an exemplary embodiment of the present invention simultaneously supports a relay mode and an MS mode.

When a relay mode of the multimode HR-MS is a time division-transmit and receive (TTR) relay mode, a single radio interface is generally used. When a relay mode of the multimode HR-MS exclusively uses the single radio interface, a terminal mode of the multimode HR-MS may not have an interface for transmission/reception.

Hereinafter, a method, i.e., a dual-role operation in which a multimode HR-MS simultaneously supports a terminal mode as well as a TTR relay mode having a single radio interface will be described.

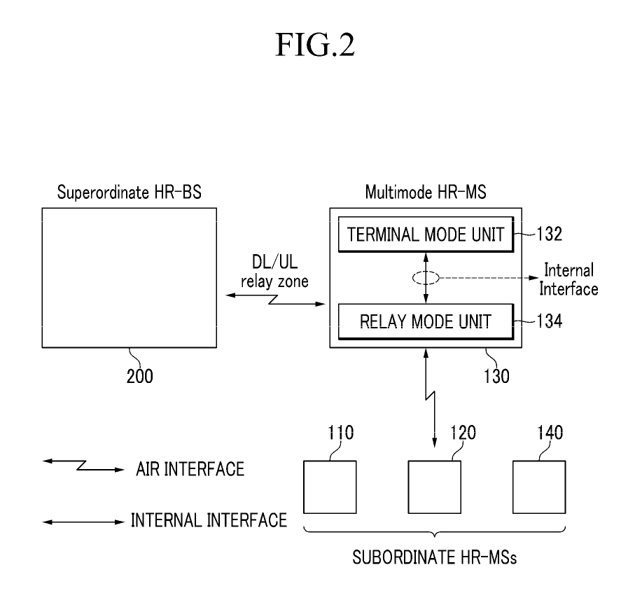

FIG. 2 is a diagram illustrating an internal configuration of a multimode HR-MS and a connection relationship between the multimode HR-MS and peripheral elements according to an exemplary embodiment of the present invention.

As shown in FIG. 2, a multimode HR-MS 130 according to an exemplary embodiment of the present invention includes a terminal mode unit 132 that support a terminal mode and a relay mode unit 134 that supports a relay mode. In order to support a terminal mode as well as a relay mode, the multimode HR-MS 130 includes an internal interface between the terminal mode unit 132 and the relay mode unit 134. Here, the internal interface is a link that can communicate between the terminal mode unit 132 and the relay mode unit 134, and may be used regardless of a kind.

The multimode HR-MS 130 according to an exemplary embodiment of the present invention uses an internal interface that connects the terminal mode unit 132 and the relay mode unit 134 for transmission/reception for a terminal mode thereof while supporting a TTR relay mode. That is, the relay mode unit 134 of the multimode HR-MS 130 receives data of a terminal mode from the superordinate HR-BS 200 through a DL relay zone, and the relay mode unit 134 transmits the data to the terminal mode unit 132 through an internal interface.

For a TTR relay mode operation, the multimode HR-MS 130 is an air interface of the superordinate HR-BS 200, forms a downlink/uplink relay zone (DL/UL relay zone), is an air interface of the subordinate terminals 110, 120, and 140, and forms a DL/UL access zone. For example, the relay mode unit 134 of the multimode HR-MS 130 receives data for the subordinate terminals 110, 120, and 140 through the DL relay zone and transmits the data to the subordinate terminals 110, 120, and 140 through the DL access zone.

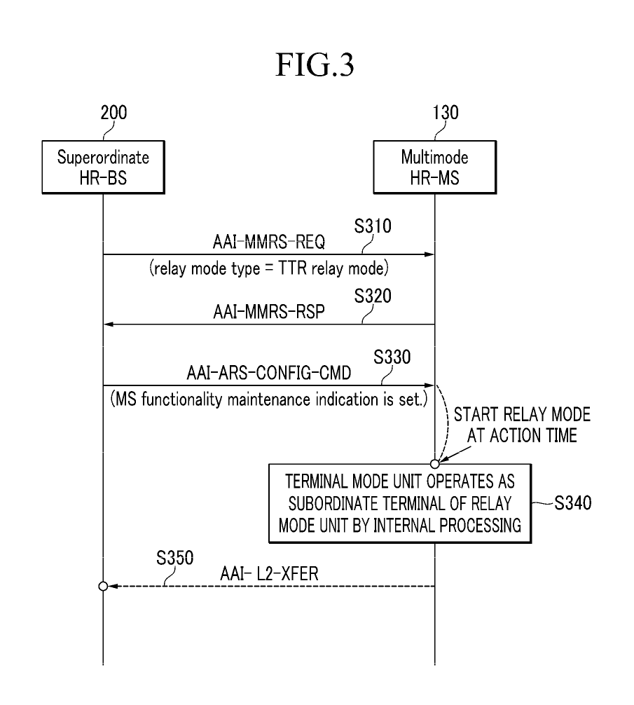

Hereinafter, a method in which the multimode HR-MS 130 forms a relay mode and a terminal mode, i.e., a dual-role operation, will be described with reference to FIG. 3.

FIG. 3 is a flowchart illustrating a method in which a multimode HR-MS forms a relay mode and a terminal mode according to an exemplary embodiment of the present invention.

First, the superordinate HR-BS 200 transmits an advanced air interface-multimode-relay station-request (AAI-MM-RS-REQ) message that requests a relay mode to the multimode HR-MS 130 (S310). Here, the AAI-MM-RS-REQ message may include contents that request to operate in a TTR mode as a relay mode. That is, a relay mode type of field within the AAI-MM-RS-REQ message is set to a TTR relay mode.

The multimode HR-MS 130 transmits and accepts an advanced air interface-multimode-relay station-response (AAI-MM-RS-RSP) message to and from the superordinate HR-BS 200 (S320).

Next, the superordinate HR-BS 200 transmits an advanced air interface-advanced relay station-config-command (AAI-ARS-CONFIG-CMD) necessary when the multimode HR-MS 130 operates in a relay mode to the multimode HR-MS 130 (S330), and the AAI-ARS-CONFIG-CMD message includes contents that request to maintain a terminal mode. That is, an MS functionality maintenance indication field of fields within the AAI-ARS-CONFIG-CMD message is set to terminal mode maintenance.

When an action time is started in a superframe number action field of fields within the AAI-ARS-CONFIG-CMD message, the multimode HR-MS 130, having received the AAI-ARS-CONFIG-CMD message, simultaneously maintains a terminal mode while starting a relay mode through a subsequent procedure.

As a first procedure, the multimode HR-MS 130 starts a TTR relay mode and sets a relay link with the superordinate HR-BS 200.

As a second procedure, the terminal mode unit 132 within the multimode HR-MS 130 operates as a subordinate terminal of the relay mode unit 134 by internal processing (S340). That is, the terminal mode unit 132 within the multimode HR-MS 130 operates like performing handover to the relay mode unit 134 thereof from the superordinate HR-BS. Here, a handover procedure in an air interface may be omitted, and a general handover procedure may be performed, as needed.

As a third procedure, the multimode HR-MS 130 transmits an advanced air interface L2 transfer (AAI-L2-XFER) message that requests to switch a data path on a network of a terminal mode to the superordinate HR-BS 200 (S350). The superordinate HR-BS 200, having received the AAI-L2-XFER message switches a data path to the terminal mode unit 132, as the terminal mode unit 132 of the multimode HR-MS 130 completes handover. Thereby, the relay mode unit 134 within the multimode HR-MS 130 operates like completion of a handover procedure to the terminal mode unit 132.

Through the procedure, when the relay mode unit 134 within the multimode HR-MS 130 receives downlink data traffic (service flow) for the terminal mode unit 132 from the superordinate HR-BS 200 through a DL relay zone, the relay mode unit 134 transmits corresponding data to the terminal mode unit 132 through an internal interface. In uplink data traffic, a procedure is performed in reverse order of this procedure. That is, when the relay mode unit 134 within the multimode HR-MS 130 receives uplink data traffic from the terminal mode unit 132 through an internal interface, the relay mode unit 134 transmits corresponding data to the superordinate HR-BS 200 through a UL relay zone.

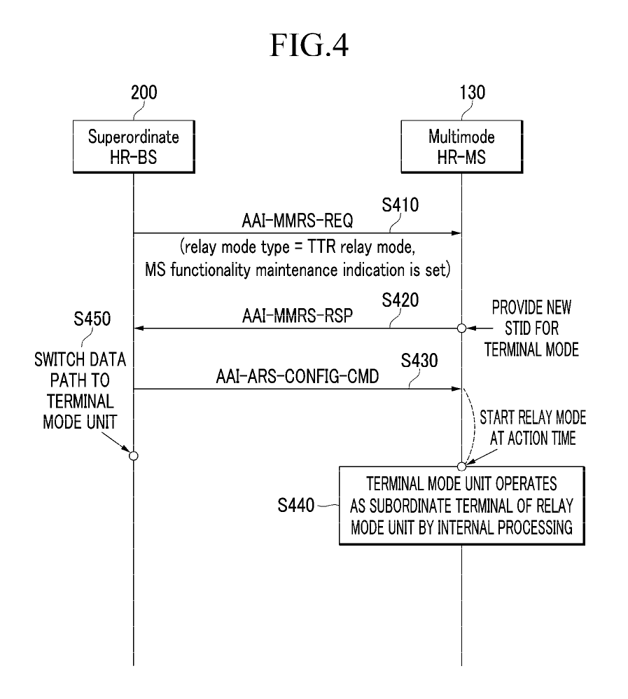

FIG. 4 is a flowchart illustrating another method in which a multimode HR-MS forms a relay mode and a terminal mode according to an exemplary embodiment of the present invention.

First, the superordinate HR-BS 200 requests a relay mode to the multimode HR-MS 130 and transmits an AAI-MM-RS-REQ message that requests to maintain a terminal mode (S410). Here, the AAI-MM-RS-REQ message includes contents that request to operate in a TTR mode as a relay mode and contents that request to maintain a terminal mode. That is, a relay mode type of field within the AAI-MM-RS-REQ message is set to a TTR relay mode, and an MS functionality maintenance indication field is set to terminal mode maintenance.

When the multimode HR-MS 130 receives a request of the superordinate HR-BS 200, the multimode HR-MS 130 provides a new station identifier (STID) for a terminal mode, writes acceptance, and transmits an AAI-MMRS-RSP to the superordinate HR-BS 200 (S420).

Next, the superordinate HR-BS 200 transmits an AAI-ARS-CONFIG-CMD message necessary when the multimode HR-MS 130 operates in a relay mode to the multimode HR-MS 130 (S430).

When an action time in a superframe number action field of fields within the AAI-ARS-CONFIG-CMD message is started, the multimode HR-MS 130, having received the AAI-ARS-CONFIG-CMD message, maintains a terminal mode while starting a relay mode through a subsequent procedure.

As a first procedure, the multimode HR-MS 130 starts a TTR relay mode and sets a relay link with the superordinate HR-BS 200.

As a second procedure, the terminal mode unit 132 within the multimode HR-MS 130 operates as a subordinate terminal of the relay mode unit 134 by an internal processing (S440). That is, the terminal mode unit 132 within the multimode HR-MS 130 operates like performing handover to the relay mode unit 134 thereof from the superordinate HR-BS 200. Here, a handover procedure in an air interface may be omitted, and a general handover procedure may be performed, as needed.

As a third procedure, unlike a case of FIG. 3, the superordinate HR-BS 200 switches a data path to the terminal mode unit 132 even without receiving a separate AAI-L2-XFER message (S450). Thereby, the relay mode unit 134 within the multimode HR-MS 130 operates like completion of a handover procedure to the terminal mode unit 132.

Through the procedure, when the relay mode unit 134 within the multimode HR-MS 130 receives downlink data traffic (service flow) for the terminal mode unit 132 from the superordinate HR-BS 200 through a DL relay zone, the relay mode unit 134 transmits corresponding data to the terminal mode unit 132 through an internal interface. In uplink data traffic, a procedure is performed in reverse order of this procedure. That is, when the relay mode unit 134 within the multimode HR-MS 130 receives uplink data traffic from the terminal mode unit 132 through the internal interface, the relay mode unit 134 transmits corresponding data to the superordinate HR-BS 200 through a UL relay zone.

In this way, the multimode HR-MS 130 according to an exemplary embodiment of the present invention can simultaneously maintain a terminal mode while performing a relay mode. According to an exemplary embodiment of the present invention, for transmission/reception in a terminal mode thereof, a terminal does not require a new zone of a frame unit or a superframe unit, and thus embodiment complexity does not increase.

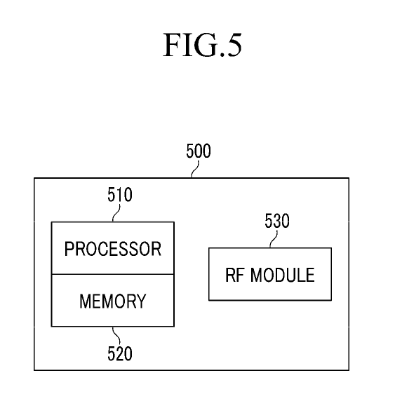

FIG. 5 is a block diagram illustrating a configuration of a multimode HR-MS according to an exemplary embodiment of the present invention.

Referring to FIG. 5, a multimode HR-MS 500 includes a processor 510, a memory 520, and a radio frequency (RF) module 530. The processor 510 is formed to embody the above-described procedure and/or method, and the processor 510 includes a terminal mode unit 132 and a relay mode unit 134 that are described in FIG. 2. The memory 520 is connected to the processor 510 and stores various information that is related to operation of the processor 510. The RF module 530 is connected to the processor 510 and transmits and/or receives a wireless signal. The multimode HR-MS 500 may have a single antenna or multiple antennas.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of communicating in a terminal, the method comprising:
providing a terminal mode unit and a relay mode unit that are connected through an internal interface;
receiving an instruction that instructs to operate in a relay mode in which the relay mode unit supports, from a base station (BS);
setting a relay link to the BS; and
performing, by the terminal mode unit, a function as a subordinate terminal of the relay mode unit through the internal interface.

2. The method of claim 1, further comprising requesting to switch a data path of a terminal mode in which the relay mode unit supports, to the BS.

3. The method of claim 2, wherein the requesting to switch comprises transmitting an advanced air interface L2 transfer (AAI-L2-XFER) message to the BS.

4. The method of claim 1, wherein the relay mode is a time division-transmit and receive (TTR) relay mode.

5. The method of claim 1, wherein the receiving of an instruction comprises receiving an advanced air interface-advanced relay station-config-command (AAI-ARS-CONFIG-CMD) message necessary when operating in the relay mode from the BS.

6. The method of claim 5, wherein the AAI-ARS-CONFIG-CMD message comprises contents that request to maintain a terminal mode.

7. The method of claim 5, wherein the AAI-ARS-CONFIG-CMD message comprises a superframe number action field, and
the setting of a relay link is started at an action time in the superframe number action field.

8. The method of claim 1, further comprising
before the receiving of an instruction:
receiving an advanced air interface-multimode-relay station-request (AAI-MM-RS-REQ) message that requests the relay mode from the BS; and
transmitting an advanced air interface-multimode-relay station-response (AAI-MM-RS-RSP) message to the AAI-MM-RS-REQ message to the BS.

9. The method of claim 8, wherein the AAI-MM-RS-REQ message comprises contents that request to operate in a TTR mode as the relay mode.

10. The method of claim 8, wherein the AAI-MM-RS-REQ message comprises contents that request to operate in a TTR mode as the relay mode and contents that request to maintain a terminal mode.

11. The method of claim 10, further comprising providing a new station identifier (STID) for the terminal mode before transmitting the AAI-MM-RS-RSP message.

12. A terminal, comprising:
a radio frequency (RF) module; and
a processor comprising a terminal mode unit and a relay mode unit that are connected through an internal interface,
wherein the processor enables a BS to set a relay link and enables the terminal mode unit to operate as a subordinate terminal of the relay mode unit through the internal interface, when a first message, which is an instruction that instructs to operate in a relay mode in which the relay mode unit supports, is received from the BS.

13. The terminal of claim 12, wherein the processor switches a data path of a terminal mode in which the terminal mode unit supports, by transmitting an AAI-L2-XFER message to the BS.

14. The terminal of claim 12, wherein the relay mode is a TTR relay mode.

15. The terminal of claim 12, wherein the first message is an AAI-ARS-CONFIG-CMD message necessary for operating in the relay mode.

16. The terminal of claim 15, wherein the first message comprises contents that request to maintain a terminal mode.

17. A method of communicating in a BS, the method comprising:
transmitting a message that requests to operate in a relay mode to a terminal that supports the relay mode and a terminal mode;
receiving a response message to the message from the terminal; and
transmitting a message that instructs to operate in the relay mode while maintaining the terminal mode to the terminal.

18. The method of claim 17, wherein the terminal comprises a relay mode unit that supports the relay mode and a terminal mode unit that supports the terminal mode, and
the relay mode unit and the terminal mode unit are connected to an internal interface.
